(19) United States
(12) Patent Application Publication
(10) Pub. No.: US 2006/0119759 A1
(43) Pub. Date: Jun. 8, 2006

(54) Liquid crystal display

(76) Inventor: Ching-Hsien Huang, Chunghe City (TW)

Correspondence Address: LEONG C LEI, PMB # 1008, 1867 YGNACIO VALLEY ROAD, WALNUT CREEK, CA, 94598, US

(21) Appl. No.: 11/002,069

(22) Filed: Dec. 3, 2004

(51) Int. Cl. G02F 1/1333

(52) U.S. Cl. 349/58

(57) ABSTRACT

A liquid crystal display includes a display, multiple signal and power connectors; a hinge on the back of the display; a base provided with a combination part connected to the hinge; an opening facing a gap on the front of the display being provided below the combination part; the depth of the gap not less than the distance between the hinge to the bottom of the display for swiveling the display to indicate horizontal status to allow easy visibility of those connectors to facilitate their connection.

### BACKGROUND OF THE INVENTION

(a) Technical Field of the Invention

The present invention is related to a liquid crystal display, and more particularly, to one that indicates the forward swivel of the display in horizontal status for the user to easily have visual contact with the signal connector and the power connector provided on the back of the display to facilitate connection of signal cable and power cable.

(b) Description of the Prior Art

As taught in the Taiwan patent publication #35115 1, the construction of liquid crystal displays generally available in the market is comprised of a display connected to a base for the adjustment of the elevation of the display. A pivoting structure is provided on the base to adjust the revolving angle. To keep cables connecting external signal source and power source from being exposed in the front of the display, signal and power connectors are provided on the back of the display.

However, upon connecting those signal and power cables the back of the display must be swiveled to its left or right by the operation of the pivoting structure for the user to see those connectors since as limited by the forward swivel angle of the display due to block by the base. Whereas the base of the LCD of the prior art is disposed at the very central position of the display to prevent the display from tiling over due to its inherited weight, a space for swivel must be reserved to the peripheral of the LCD when the swivel of the display to its left or right with the base as the center is desired. Meanwhile, the radius of the space reserved must be greater than half a width of the display. On considering that the least space consumption is one of the primary advantages of the LCD, the reservation of a large space for swivel of the display as demanded by the connection of those signal and power cables, such advantage of least space consumption fails to be realized. Furthermore, the LCD is usually placed at where close to a wall and the peripherals including a mouse and a keyboard are provided at where below the front of the LCD. The arrangement makes it more difficult to swivel the display to its right or left. Accordingly a proper spacing must be reserved between the LCD and the wall, and the peripherals including the mouse and the keyboard must be removed from their original locations to make connection of those cables quite awkward.

### SUMMARY OF THE INVENTION

The primary purpose of the present invention is to provide an improved structure for an LCD that allows facilitated connection of signal and power cables. To achieve the purpose, the present invention is comprised of a display and a base. The display has provided on its back multiple signal connectors and power connectors to connect external signal and power sources; and provided on its back multiple hinges at a proper distance from the bottom of the display. The base includes a combination part to connect to those hinges of the display so to adjust the elevation angle of the display. An opening facing a gap provided on the front of the display is provided at where below the combination part and the depth of the gap is greater than the distance between those hinges and the bottom of the display.

Accordingly, the gap allows the display to swivel forward to indicate horizontal status for the user to easily see those connectors provided on the back of the display to facilitate the connection of signal and power cables.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A and 1B are exploded views of a preferred embodiment of the present invention.

FIG. 2 is a blowout view of a local part of the preferred embodiment of the present invention.

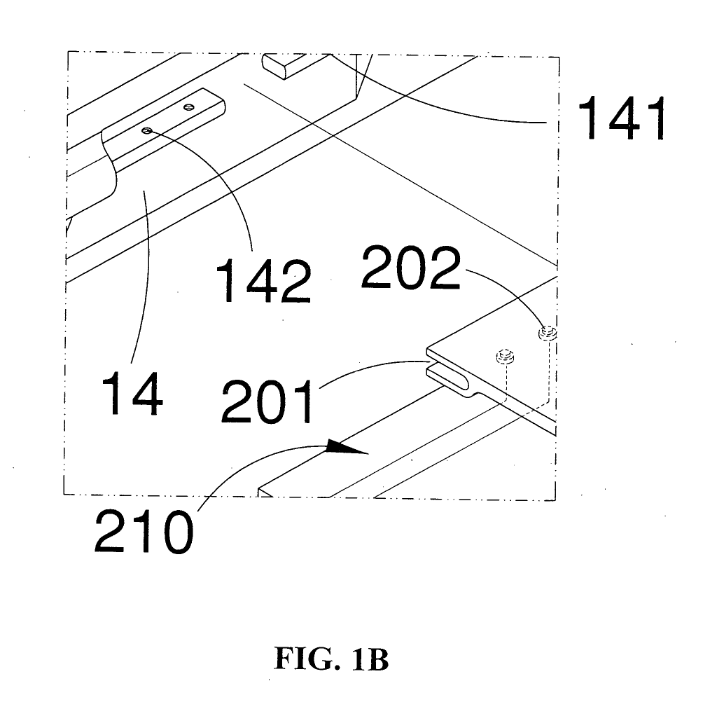

FIG. 3 is a perspective view showing the preferred embodiment of the present invention as assembled.

FIG. 4 is a side view of the preferred embodiment of the present invention.

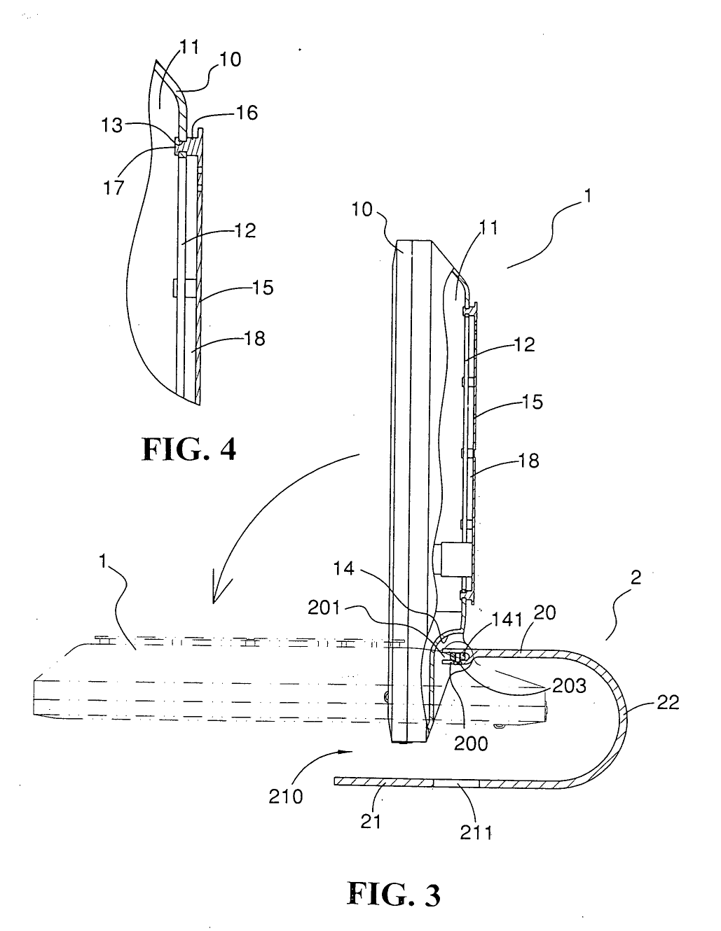

FIG. 5 is a schematic view showing the swivel motion of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

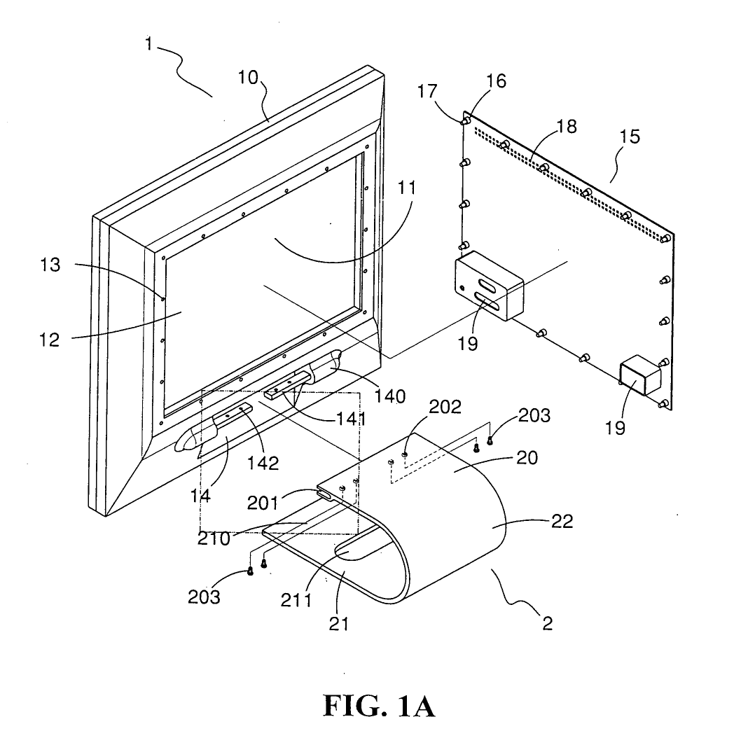

Referring to FIGS. 1A. and 1B. through 4, a preferred embodiment of the present invention is essentially comprised of a display (1) and a base (2) pivoted to the back of the display (1) to permit proper adjustment of the elevation angle of the display (1) n the base (2).

Wherein, the display (1) includes a casing (10) containing a space (11) to accommodation circuit boards and electronic components; a rectangular hole (12) is disposed at the center of the back of the casing (10) to connect through the space (11); multiple combination holes (13) penetrating through the back of the casing (10) are provided at a proper spacing to the peripheral of the rectangular hole (12); a pivoting trough (14) is provided in recess on the back of the casing (10) at where close to the bottom of the display (1); a pivoting holder (140) is each protruding from both sides of the pivoting trough (14); a hinge (141) extending into the pivoting trough (14) is each provided on both pivoting holders (14); and multiple bolting holes (142) are provided on the hinge (141); and the hinge (141) is provided with two sections of swivel angles, respectively, leaning forward for 90˜5 degrees for the first section, and leaning forward for 5 degrees and leaning backward for 20 degrees for the second section.

A back plate (15) provided over the rectangular hole (12) having provided on the peripheral of its inner surface multiple studs (16) with each stud (16) disposed on its top a combination rod (17) in a diameter slight smaller than that of the stud (16) to be inserted into its respective combination hole (13); the portion of the combination rod exposed from the inner side of the combination hole (13) is fused for fixation to the inner side of the casing (10) to prevent it from falling out of place while the stud (1 5) secures the back plate (15) to where allowing a certain range above the rectangular hole (12) for the spacing between any abutted studs (16) to define a sideway ventilation hole (18) that is connected through the space (11); and multiple through holes (10) are disposed on the back plate (15) to receive a signal connector (190) and a power connector (191) provided in the space (11) for connection to external signal and power sources.

The base (2) includes a fixation plate (20), a support plate (21) and a combination plate (22). The fixation plate (20) is horizontally provided with one end disposed with a combination part (200) containing a locking slot (201) with a front opening to receive the installation by insertion of the hinge (141); multiple through holes (202) penetrating through the bottom of the base (2) are provided on the bottom of the locking slot (201) for a screw (203) to penetrate through and be locked into the bolting hole (141) provided on the hinge (141) so to combine the display (1) to the base (2).

The support plate (21) is located below the fixation plate (20) approximately in parallel with the fixation plate (20) to define a gap (21) with its open facing forward and its depth greater than the distance between the hinge (141) of the display and the bottom of the display (1); a slotted hole (211) penetrating through the support plate (21) is provided on the support plate (21) to facilitate the access by a handle tool to tighten up the screw (203) into the through hole (202).

The combination plate (22) in a semi-circular shape has its upper edge connected to one side of the fixation plate (20) and its lower edge connected to one side of the support plate (21) for the base (2) to approximately indicate a U shape with opening facing forward.

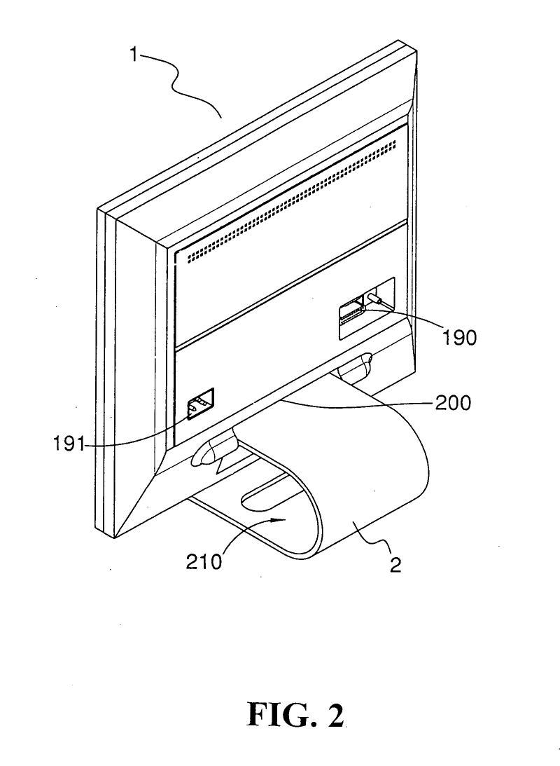

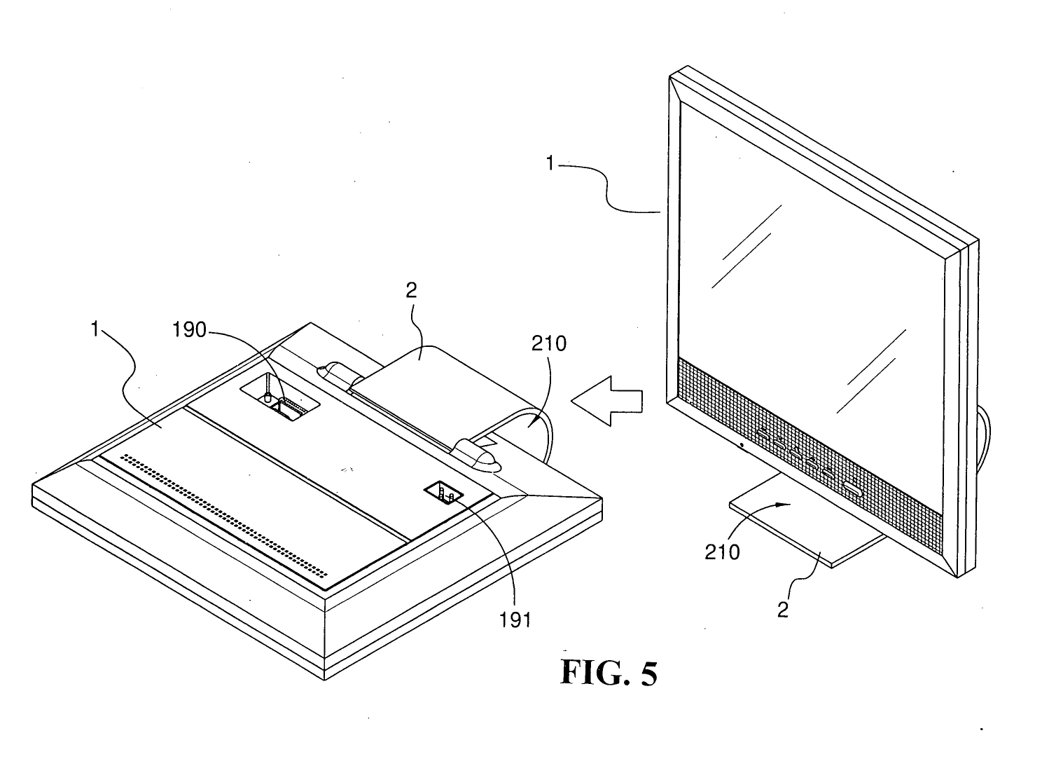

Now referring to FIGS. 3 and 5 with the display (1) learning forward for 90 degrees to indicate a horizontal status, the portion of the display below the hinge (141) is merely falling into the gap (210) of the base (2) for the user to easily see the signal connector (190) and the power connector (191) disposed on the back of the display (1) thus to facilitate the connection of signal and power cables. Meanwhile, the space required for the leaning forward of the display (1) is located at the very front of the display (1) where usually is related to a cleared space. Furthermore, when the display (10) leans forward for 90 degrees, its front side keeps a certain distance from the support plate (21) of the base (20) without being subject to the blocking by the peripherals including a mouse and a keyboard. Accordingly, while leaning forward the display (1), it is not necessary to relocate those peripherals to facilitate the connection of the signal and power cables.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A liquid crystal display includes a display and a base; multiple signal connectors and power connectors being provided on the back of the display; a hinge being provided on the back of the display at a certain distance away from the bottom of the display; a combination part being disposed to the base to combine with the hinge of the display; an opening being provided below the combination part facing a gap disposed on the front side of the display; the depth of the gap being greater than the distance between the hinge of the display and the bottom of the display.

2. The liquid crystal display of claim 1; wherein, the display includes a casing and a back plate; a space being provided in the casing to accommodate circuit boards and electronic components; a rectangular hole connecting through the space being provided at the center of the back of the casing; the back plate being provided on the hole; multiple studs at a proper spacing being provided on the peripheral of the inner side of the back plate and on the peripheral of the rectangular hole of the back plate to define sideway ventilation holes that connect through the space.

3. The liquid crystal display of claim 2; wherein, multiple combination holes are provided at a proper spacing on the peripheral of the rectangular hole of the casing; a combination rod in diameter less than that of the stud being provided at the top of the stud to insert into the combination hole; the portion of the combination rod exposed from the inner side of the combination hole being fused to the inner side of the casing to prevent from falling of its position.

4. The liquid crystal display of claim 2; wherein, a pivoting trough being provided in recess below the back of the casing; a pivoting holder being each protruded from both sides of the pivoting trough; and a hinge extending into the pivoting trough being each provided on both pivoting holders to incorporate with the combination part of the base.

5. The liquid crystal display of claim 2; wherein, multiple through holes are provided on the back plate for the installation of the signal connector or the power connector.

6. The liquid crystal display of claim 1; the base includes a fixation plate, a support plate, and a combination plate; the fixation plate horizontally provided with one end disposed with the combination part to connect the hinge from the display for the display to swivel for proper angles on the base; the support plate fixed below the fixation plate and in parallel with the fixation plate to define a gap between the fixation plate and the support plate; and the combination plate related to an arc plate with its upper edge combined to one side of the fixation plate and the lower edge combined to one side of the support plate for the base to approximately indicate a U shape.

7. The liquid crystal display of claim 6; wherein, a pivoting trough being provided in recess below the back of the display, a pivoting holder being each protruded from both sides of the pivoting trough, a hinge extending into the pivoting trough being each disposed on both pivoting holders; multiple screwed holes being provided on the hinge; the combination part including a locking slot with an opening facing forward to receive insertion of the hinge; multiple through holes penetrating through the bottom of the display being provided at the bottom of the locking slot to receive insertion of screws for securing the base to the display.

8. The liquid crystal display of claim 7; wherein, a slotted hole penetrating through the support plate being provided on the support plate to permit easy access for the screw to lock into the through hole.

9. The liquid crystal display of claim 1; wherein, the hinge provides two sections of swivel angles; the first section being provided for leaning forward for 90˜5 degrees; and the second section, leaning forward for 5 degrees and leaning backward for 20 degrees.
